(19) United States
(12) Patent Application Publication
(10) Pub. No.: US 2026/0148204 A1
(43) Pub. Date: May 28, 2026

(54) Opportunity Server Systems and Methods

(71) Applicant: Reginald Ratliff, Fremont, CA (US)

(72) Inventor: Reginald Ratliff, Fremont, CA (US)

(73) Assignee: Reginald Ratliff, Fremont, CA (US)

(21) Appl. No.: 19/056,677

(22) Filed: Feb. 18, 2025

Related U.S. Application Data
(60) Provisional application No. 63/553,715, filed on Feb. 15, 2024.

(51) Int. Cl. G06Q 10/42

(52) U.S. Cl. CPC G06Q 10/42

(57) ABSTRACT

A method is disclosed. The method includes determining a prime mover initiative, determining a factors of production profile that corresponds to the prime mover initiative, using the factors of production profile, identifying enablers that possess one or more factors of production that are specified by the factors of production profile, and providing identifiers of the identified enablers to a prime mover that is associated with the prime mover initiative.

### CROSS-REFERENCE TO RELATED APPLICATIONS

This application claims benefit of U.S. Provisional Patent Application No. 63/553,715, filed Feb. 15, 2024, and U.S. Provisional Ser. No. 63/637,895 filed Apr. 24, 2024, which are incorporated by reference herein in their entirety.

### TECHNICAL FIELD

Embodiments of the disclosure pertain to network platforms, and more particularly to an opportunity server networking platform.

### BACKGROUND

Conventional social media platforms that are primarily used for professional networking and career development, allow registered users and jobseekers to post their CVs, and allows employers to post jobs. The focus of such platforms which is primarily on job listings provided by companies limits their utility.

### BRIEF DESCRIPTION OF THE DRAWINGS

FIG. 1A shows a block diagram of an example of an environment 10 in which an on-demand database service can be used in accordance with one embodiment.

FIG. 1B shows components accessed by prime movers 12₁-12n to organize talent and resources around opportunities according to one embodiment.

FIG. 1C illustrates the structure of a factors of production profile according to one embodiment.

FIG. 1D shows how the opportunity server system identifies a factors of production profile based on a prime mover initiative and then uses the factors of production profile to identify opportunity server system users who possess the human and non-human resources that are needed to support the prime mover initiative.

FIG. 1E illustrates the use of a factors of production profile to identify the human and non-human resources needed to operationalize a manufacturing initiative according to one embodiment.

FIG. 1F shows the manner in which possessors of human and non-human resources identified using a factors of production profile can be ranked according to one embodiment.

FIG. 1G shows the manner in which the opportunities generated by prime movers can be categorized according to one embodiment.

FIG. 1H shows the manner in which enablers of prime mover initiatives are matched via a network to a prime mover initiative data storage according to one embodiment.

FIG. 1I shows the manner in which an enabler can prompt a proactive search and identification of opportunities based on the factors of production or human and/or non-human resources that he/she possesses.

FIG. 1J illustrates the manner in which funders are platformed and provided visibility into the current prime mover initiatives according to one embodiment.

FIG. 1K shows a graphical user interface (GUI) of the opportunity server according to one embodiment.

FIG. 2 shows components of a system for identifying enablers for a prime mover initiative of opportunity server system according to one embodiment.

FIG. 3 shows components of a system for identifying a prime mover initiatives of an opportunity server system according to one embodiment.

FIG. 4A shows a flowchart of a method for identifying enablers for a prime mover initiative according to one embodiment.

FIG. 4B shows a flowchart of a method for notifying enablers of their selection for a prime mover initiative according to one embodiment.

FIG. 5 shows a flowchart of a method for identifying prime mover initiatives according to one embodiment.

### DESCRIPTION OF THE EMBODIMENTS

An opportunity server is described. It should be appreciated that although embodiments are described herein with reference to example opportunity server, the disclosure is applicable to opportunity servers in general as well as other kinds of opportunity servers. In the following description, numerous specific details are set forth, such as specific integration and material regimes, in order to provide a thorough understanding of embodiments of the present disclosure. It will be apparent to one skilled in the art that embodiments of the present disclosure may be practiced without these specific details. In other instances, well-known features, such as integrated circuit design layouts, are not described in detail in order to not unnecessarily obscure embodiments of the present disclosure. Furthermore, it is to be appreciated that the various embodiments shown in the Figures are illustrative representations and are not necessarily drawn to scale.

Certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

As used herein the term “enabler” is intended to refer to those who possess human or non-human resources or “factors of production” that are needed to operationalize an entrepreneurial, business or investment initiative. For example, enablers can include those who possess or control labor, land, capital, and entrepreneurial skill. Accordingly, enablers can be non-entrepreneurs or entrepreneurs.

As used herein the term “prime mover” is intended to refer to a person who initiates a search for business, investment and/or entrepreneurial enablers.

As used herein the term “prime mover initiative” is intended to refer to a business, investment, entrepreneurial or other type of profit or non-profit initiative that is initiated by a prime mover.

As used herein the term “factors of production” is intended to refer to land, labor and entrepreneurship.

As used herein the term “talent and resources” is intended to refer to factors of production.

As used herein the term “factors of production profile” is intended to refer to a profile that specifies the factors of production (human and non-human resources) that are needed to operationalize a entrepreneurial, business and/or investment initiative.

Conventional social media platforms that are primarily used for professional networking and career development, allow registered users and jobseekers to post their CVs and employers to post jobs. Job opportunities are generally limited to those that are provided by established companies.

Platforms such as these are consistent with and reinforce a paradigm where employers are positioned to pick and choose from available candidates that qualify for a particular opportunity. The listing of the opportunities are based on the needs of established employers. Several candidates are forced to respond to each job opportunity that is generated by employers. Many job seekers can never find opportunities that truly match their talent and abilities. Others that can find good opportunities initially, later are unable to advance into positions that allow them to take full advantage of their experience, expertise and/or capabilities. Accordingly, enormous business, entrepreneurial and professional potential is lost or underutilized. Conventional systems do not empower registered users to generate opportunities themselves.

A method is disclosed herein that addresses the aforementioned challenges. In one embodiment the method includes determining a prime mover initiative, determining a factors of production profile that corresponds to the prime mover initiative, using the factors of production profile, identifying enablers that possess one or more factors of production that are specified by the factors of production profile, and providing identifiers of the identified enablers to a prime mover that is associated with the prime mover initiative.

Using the systems and methods described herein, when a prime mover identifies an entrepreneurial, business or investment opportunity, that they would like to pursue, the prime mover can initiate a search for the factors of production (human and non-human resources) that are needed or are involved in operationalizing and supporting the opportunity. In one embodiment, the prime mover can initiate the search for the factors of production via an interface associated with the system described herein by making appropriate selection(s) on a screen of a networked device that displays an interface of the system. Thus, a prime mover can autonomously operationalize opportunities through the convenience of a personal device.

In addition, in one embodiment, when an enabler wants to identify opportunities to provide the factors of production that they control or possess, the enabler can initiate a search for such opportunities among those that have been generated by prime movers. In one embodiment, the enabler can initiate the search for the opportunities to provide the factors of production by making appropriate selection(s) on the screen of a networked device that displays the interface. Thus, in one embodiment, an enabler can autonomously identify opportunities to provide factors of production that they control or possess.

### Opportunity Server

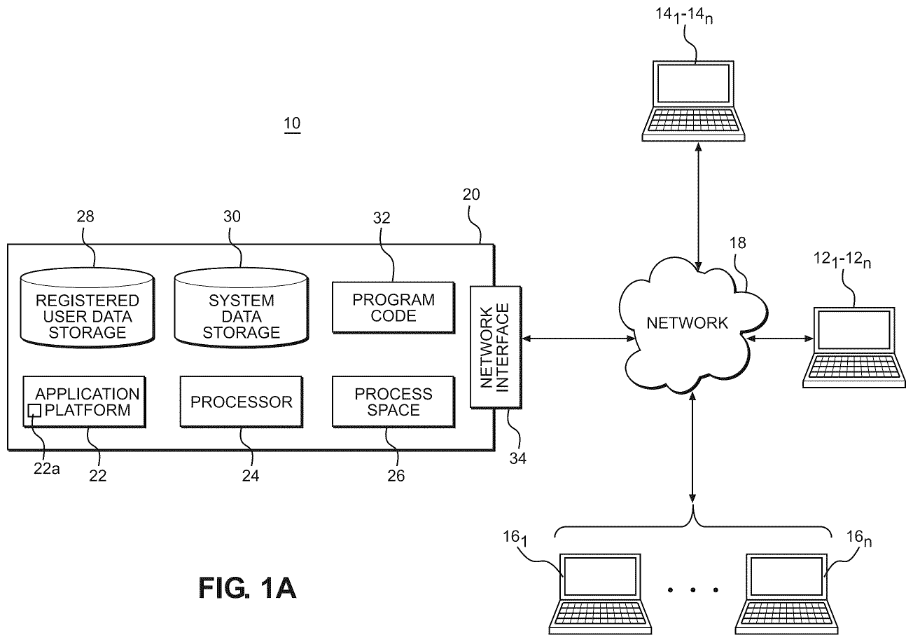

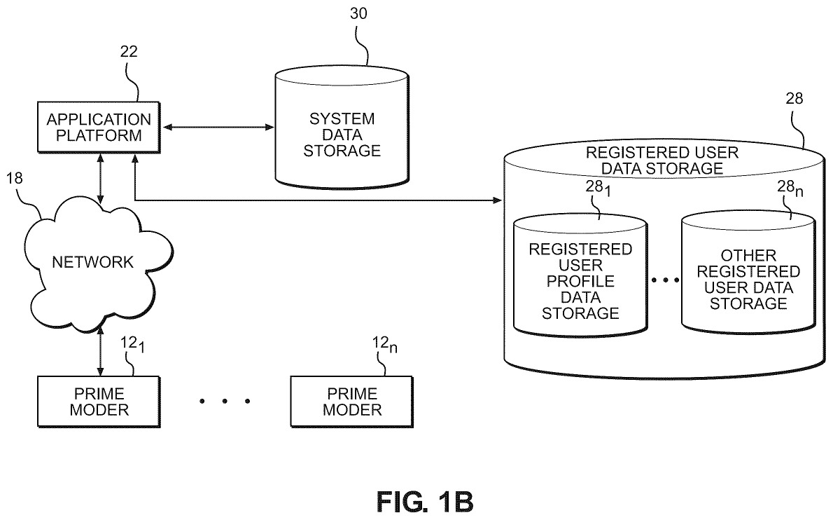

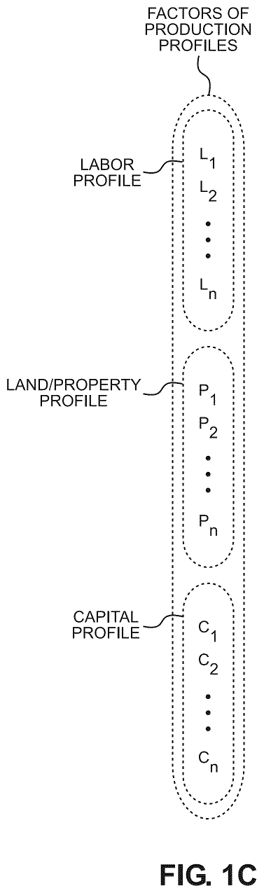

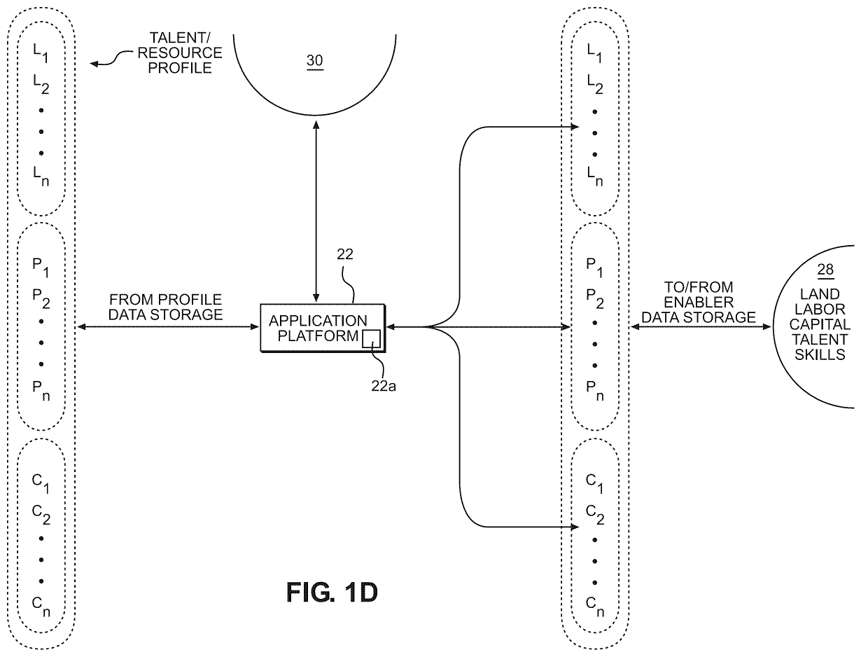

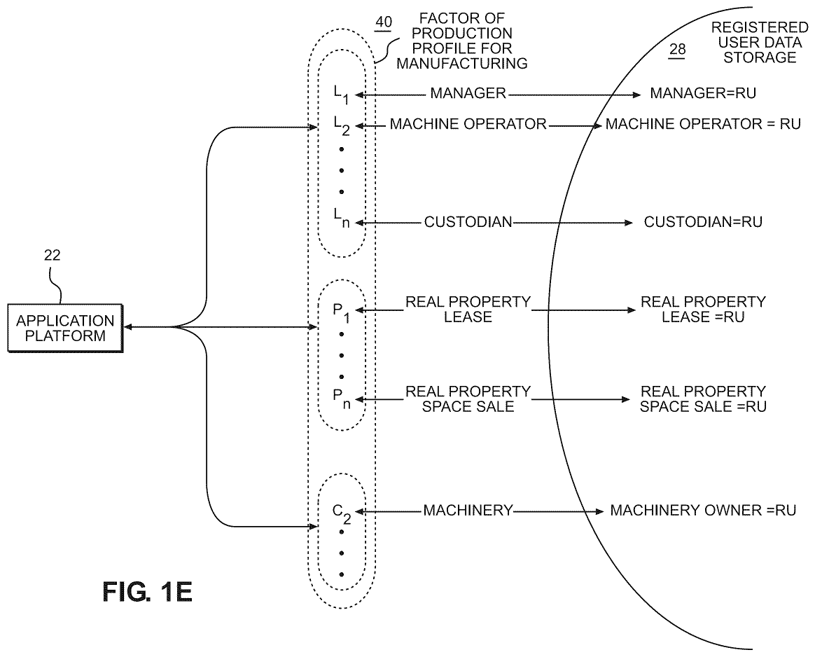

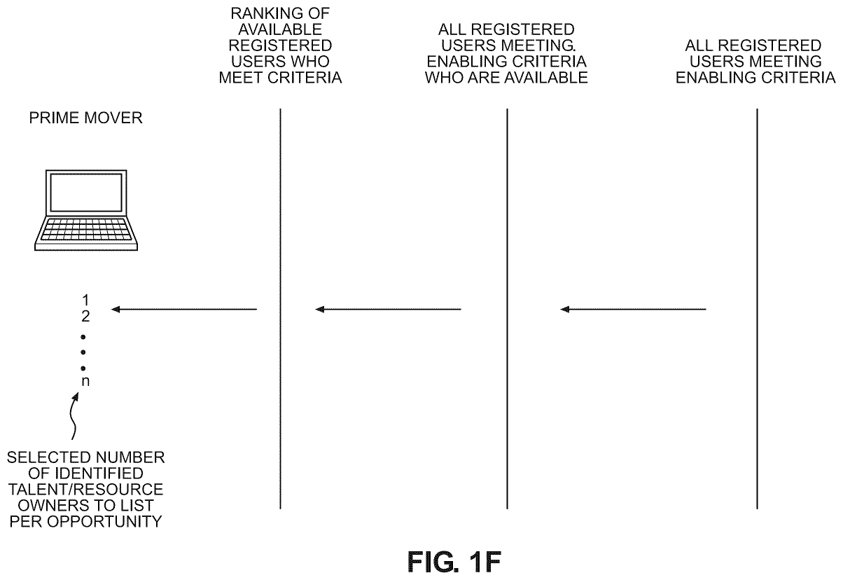

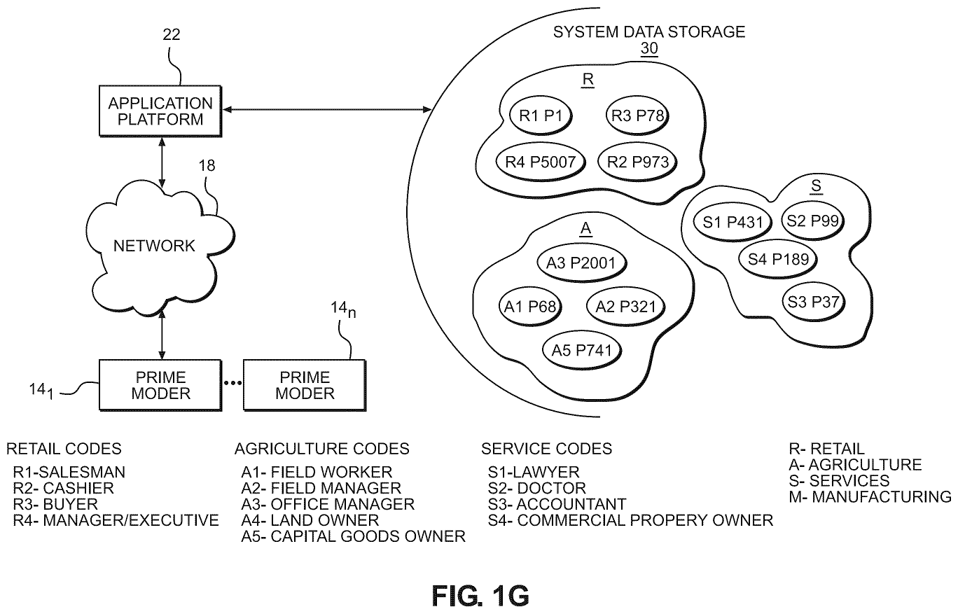

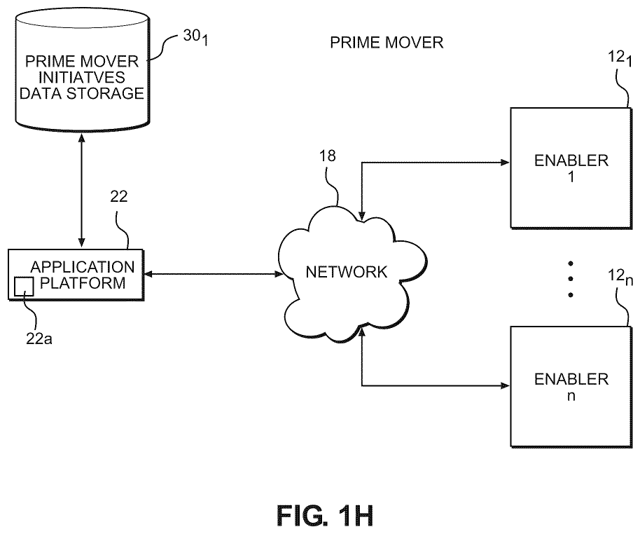

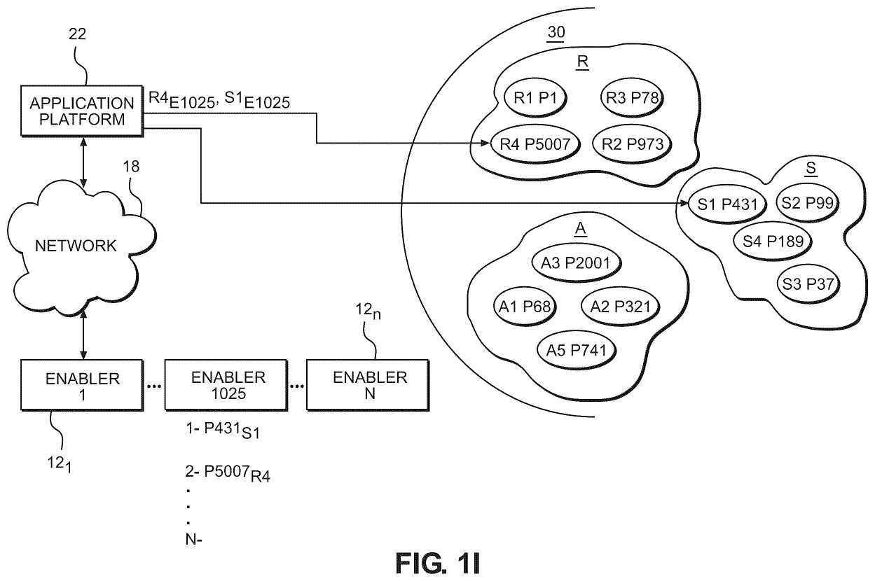

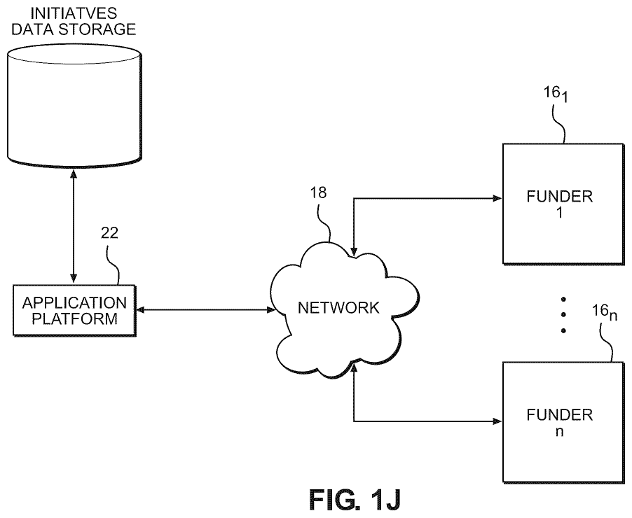

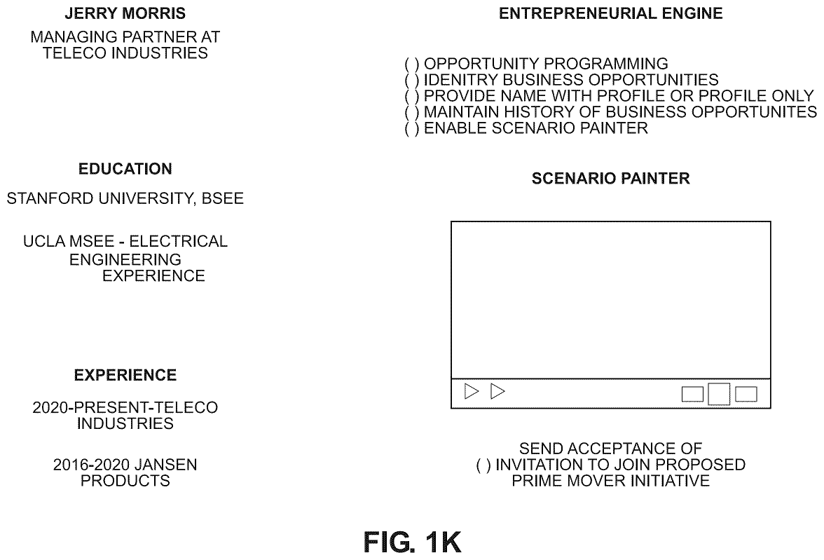

FIG. 1A shows a block diagram of an example environment 10 in which an opportunity server system can be used in accordance with one embodiment. The environment 10 includes prime movers 12₁-12ₙ, enablers 14₁-14ₙ, and funders 16₁-16ₙ, network 18, computer system 20 (e.g., for example a “cloud-based computer system”), application platform 22, processor system 24, process space 26, registered user data storage 28 for storing registered user data, system data storage 30 for storing system data, program code 32, and network interface 34, for implementing various functions of the platform, and for executing platform processes and registered user specific processes, such as running applications as part of an application hosting service. In some other implementations, environment 10 may not have all of these components or systems, or may have other components or systems instead of, or in addition to, those listed above.

FIG. 1B shows components accessed by prime movers 12₁-12n to organize talent and resources around opportunities according to one embodiment. FIG. 1B shows in addition to the components described with reference to FIG. 1A, registered user profile data storage 28₁ and other registered user data storage 28ₙ. Referring to FIG. 1B, prime movers 12₁-12ₙ can access talent and resource profiles from system data storage and use the talent and resource profiles to identify registered users who possess the needed talent and resources from the registered user profile data storage of the registered user data storage.

FIG. 1C illustrates the structure of a factors of production profile according to one embodiment. In one embodiment, the factors of production profiles can include but are not limited to labor profiles (including labor roles L₁-Lₙ), land/property profiles (including property types P₁-Pₙ), capital profiles (including capital types C₁-Cₙ) and entrepreneurial (if prime mover is not an entrepreneur) profile. In one embodiment, factors of production profiles specify the human and non-human resources that are needed to operationalize businesses. In one embodiment, factors of production profiles that specify the talent and resources that are needed for a every type of business is store by the system in one or more data storage devices. In one embodiment, the factors of production profiles are used to identify system users that can include but are not limited to owners/possessors of labor, property, capital, land, and entrepreneurial initiative and/or skill that can support and/or enable the operationalization of an entrepreneurial initiative.

FIG. 1D shows how system 22a identifies a factors of production profile based on an entrepreneurial initiative and then uses the factors of production profile to identify system users who possess the human and non-human resources that are needed to support the entrepreneurial initiative. In one embodiment, an entrepreneur can edit the talent and resource profile before it is used to identify system users who possess the talent and resources that are needed to enable the operationalization of the entrepreneurial initiative. Referring to FIG. 1D, opportunity server system 22a accesses a talent and resource profile that corresponds to the entrepreneurial initiative from system data storage 30 and then uses the talent and resource profile to search the registered user data storage 28 to identify registered users who possess the talent and resources that are needed to enable the operationalization of the entrepreneurial initiative.

FIG. 1E shows the use of a factors of production profile to identify talent and resources needed to operationalize a manufacturing initiative according to one embodiment. Referring to FIG. 1E, application platform 22 utilizes a talent and resource profile 40 corresponding to a manufacturing initiative that includes talent specifiers that include a manager, a machine operator and a custodian. In addition, the factors of production profile 40 includes land specifiers that include owners of real property for lease and real property for sale. And, the talent and resource profile 40 includes a capital specifier that includes industrial machinery. The factors of production profile 40 is used to search the registered user data storage 28 for registered users who possess the factors of production that match the factors of production specified in the factors of production profile 40 as being needed to support the prime mover initiative with which it is associated.

FIG. 1F shows the manner in which talent and resources identified using the factors of production profile can be ranked according to one embodiment. Referring to FIG. 1F, initially all of the registered users meeting the criteria specified in the talent and resource profile are identified by the system 22a. From this group, system 22a identifies the registered users who meet the criteria and who are available. Next, system 22a ranks the registered users that meet the criteria and who are available. Finally, the system 22a prompts a display of a number of the ranked registered users that is specified by the prime mover to be displayed.

FIG. 1G shows the manner in which the opportunities generated by prime movers can be categorized according to one embodiment. Referring to FIG. 1G, the opportunities generated by prime movers can be categorized according to the type of economic activity that is involved, for example service, retail, agricultural, manufacturing, etc. Moreover, within a category of economic activity, the specific resource that is needed by a prime mover, and the prime mover that needs the specific resource, can be identified. For example, as shown in FIG. 1G, under the category retail, designated by the letter “R”, needed labor resources such as salesman (R1), cashier (R2), buyer (R3) and manager (R4) are indicated as needed by prime movers P1, P973, P78 and P5007 respectively. The processes illustrated in FIG. 1G, enable enablers who were not identified for these opportunities directly by the prime mover (see FIGS. 1D and 1E), to identify opportunities for themselves, and to indicate their interest directly to the prime mover if the prime mover has indicated that as part of their search for resources they can be contacted directly by interested enablers. It should be noted that for purposes of clarity and brevity, the FIG. 1G illustration, only depicts labor opportunities for the depicted areas of economic activity, but each area of economic activity can also include opportunities related to the other factors of production such as land/property, capital goods and entrepreneurship. In addition, labor resources for manufacturing are not shown in FIG. 1G.

FIG. 1H shows the manner in which enablers of prime mover initiatives are coupled via network 18 to prime mover initiative data storage 301 according to one embodiment. In one embodiment, the prime mover initiative data storage 301 can be a part of the system data storage 30 in which identifiers of generated prime mover initiatives are stored (see FIG. 1G). Referring to FIG. 1H, enablers 121-12n can access initiative data storage 301 by prompting the system 22a of the application platform 22 to identify opportunities for enablers 121-12n. In one embodiment, an enabler 121-12n can prompt the application platform 22 by graphically selecting a graphical object or otherwise interacting with graphical elements of the display of a networked device of the enabler as may be presented as part of a graphical user interface.

FIG. 1I shows the manner in which an enabler can prompt a proactive search and identification of opportunities based on the factors of production or human and/or non-human resources that he/she possesses. Referring to FIG. 1I, in one embodiment, based on the factors of production and/or human and/or non-human resources that an enabler E1025 possesses, opportunities associated with prime mover initiatives that are active (and have been indicated by the prime mover as being ones that are open to interested enablers), and that require non-human and/or human resources that matches the non-human and/or human resources that the enabler possesses, can be identified and presented to the enabler.

FIG. 1J illustrates the manner in which funders are platformed and provided visibility into the current prime mover initiatives according to one embodiment. In one embodiment, all types of funders can be platformed (e.g., provided with complete visibility into the business marketplace created on the platform and the ability to connect and communicate with prime movers). In one embodiment, a marketplace is created that is: an ideal forum for ambitious funders to compete with larger funders in the competition for the best opportunities for business growth. In one embodiment, a market is created that is difficult to ignore without consequence: if market is ceded to ambitious funders those funders are provided with an ideal forum in which to develop the wherewithal to challenge absentee funders in other forums.

### Operation

In operation, when a prime mover identifies an entrepreneurial, business or investment opportunity, the prime mover can initiate a search for the factors of production (human and non-human resources) that are needed or are involved in operationalizing the opportunity. In one embodiment, the prime mover can initiate the search for the factors of production via an interface associated with the opportunity server system 22a by making appropriate selection(s) on the screen of a personal device that displays the interface. Thus, in one embodiment, a prime mover can autonomously operationalize opportunities through the convenience of their personal device.

In one embodiment, when an enabler wants to identify opportunities to provide the factors of production that they control or possess, the enabler can initiate a search for such. In one embodiment, the enabler can initiate the search for the opportunities to provide the factors of production via an interface associated with the opportunity server system 22a by making appropriate selection(s) on the screen of a personal device that displays the interface. Thus, in one embodiment, an enabler can autonomously identify opportunities to provide factors of production.

It should be appreciated that other type profiles such as profiles that identify partner investors, partner businesses (such as for mergers or collaborations) and even trade partners can be created by users of opportunity server system 22a.

For example, in one embodiment, the opportunity server system 22a enables the creation of a profile that can be used to search data storage to identify trade partners. In particular, a prime mover can create a profile that searches data storage to identify suppliers of goods and services that are supplied by a first supplier that can be supplied by a second supplier to whom the prime mover can themselves supply goods and services (where each region maintains their supply of desired goods and services while increasing their export revenue).

For example, users of the opportunity server system 22a such as government officials or executives or employees of companies can create profiles that identify regions that import products and services from third party sources that the other can provide and who can supply products and services that they need. In this manner, users can identify the regions where re-sourcing the imported products and/or services will result in an increase in revenue for each of the regions. As part of the process, users can identify the companies residing in the identified regions that are determined to be able to supply the products and services that are in demand. In one embodiment, the opportunity server system 22a can attempt all possible matches for import re-sourcing to identify which re-sourcing scenarios yield the greatest increase in revenue

In one embodiment, in addition to the bilateral matching described above, trilateral matching can be performed. For example, if it is found that there is not a good bilateral trade re-sourcing match between two individuals, companies, countries, etc. opportunity server system 22a can determine if there are trilateral trade re-sourcing matches. For example, consider the case where a first region A (California) can be a source of products and services to a second region B (New York), but the second region B is not available as a source of desired products and services to the first region A. Because the second region B is available as a source of desired products and services to a third region C (Louisiana), and the third region C is available as a source of desired products and services to the first region A, a criterion for re-sourcing, e.g., that each region maintains their supply of desired goods and services while increasing their export revenue, is met.

It should be appreciated that, in one embodiment, the opportunity server system 22a employs artificial intelligence for purposes that include but are not limited to planning systems, expert systems, machine learning and computer vision to produce products that can include but are not limited to development models that are based on the data that the opportunity server system 22a maintains such as the herein described human and non-human resource data.

FIG. 1K shows a graphical user interface (GUI) of the opportunity server according to one embodiment. The GUI includes a section that is used to display a user's human and non-human resources such as education, experience and/or other skills and/or resources that the user may possess. The GUI also includes a section that enables a user to initiate operation of the opportunity server. Additionally, it includes a “scenario painter” that provides visual and audio descriptions of the opportunities that are provided. For example, in one embodiment, the scenario painter can include videos that describe what the opportunity is, what the opportunity means to the registered user, and what the next steps are for the registered user.

### Components of the Opportunity Server

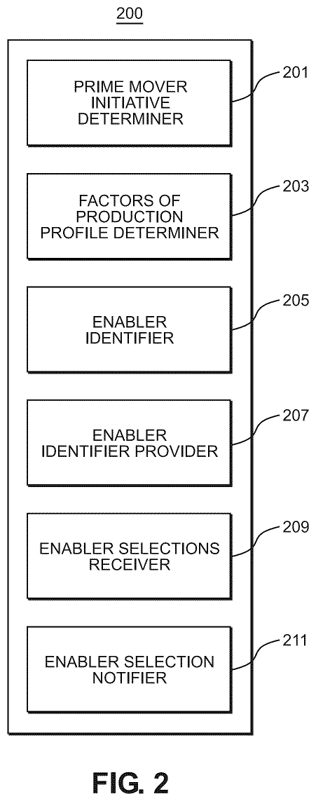

FIG. 2 shows components of a system 200 for identifying enablers for a prime mover initiative of a system 22a for opportunity serving according to one embodiment. In one embodiment, components of the system 200 for identifying enablers for a prime mover initiative of the system 22a for opportunity serving includes prime mover initiative determiner 201, factors of production profile determiner 203, enabler identifier 205, enabler identifier provider 207, enabler selections receiver 209 and enabler selection notifier 211.

Prime mover initiative determiner 201 determines a business initiative that a prime mover is interested in pursuing or is qualified to pursue. In one embodiment, an identification of the business initiative is provided by the prime mover. In one embodiment, an identification of the business initiative is determined by the system 200. In one embodiment, the system 200 can determine the business initiative by examining the personal profile of the prime mover. In one embodiment, the system 200 can determine the business initiative by examining the personal profile for information related to the prime mover that can include but is not limited to education, training, work experience and control of factors of production.

Initiative type factors of production profile determiner 203 identifies an initiative type factors of production profile that corresponds to the type of prime mover initiative that the prime mover is interested in pursuing or is qualified to pursue. In one embodiment, the initiative type factors of production profiles are maintained in data storage components associated with system 200. In one embodiment, the initiative type that the prime mover is interested in pursuing or is qualified to pursue can be provided by the prime mover or can be determined by the initiative type factors of production profile determiner 203 by examining the personal profile of a potential prime mover to determine the type of initiatives which the potential prime mover is qualified to act as a prime mover. In one embodiment, the initiative type factors of production profile that is identified can be used to identify enablers that possess the factors of production needed by the prime mover initiative.

Enabler identifier 205 identifies the prime mover initiative enablers that possess the factors of production that are needed to support the operationalization of the prime mover initiative that is associated with the prime mover. In one embodiment, enabler identifier 205 uses an initiative type factors of production profile to identify the enablers. In one embodiment, the initiative type factors of production profile can be used to search data storage components that store the personal profiles of opportunity server system 22a users. In one embodiment, when enablers are identified that match the criteria specified by the initiative type factors of production profile, their identities are provided to the prime mover associated with the initiative.

Enabler identifier provider 207 provides the identities of identified enablers to the prime mover. In one embodiment, where multiple enablers meet the criteria specified in the initiative type factors of production profile, the identities of the identified enablers that are provided to the prime mover can be ranked. In one embodiment, where multiple enablers meet the criteria specified in the profile, and the identities of the identified enablers are ranked, all of the ranked enablers identities or a specified number of the ranked enablers identities can be provided to the prime mover. In one embodiment, the specified number can determined by the prime mover. In other embodiments, the specified number can be determined by the system.

Enabler selection receiver 209 accesses an indicator of a prime mover's selection of an enabler identified by a search of data storage components using the initiative type factors of production profile that is identified for the prime mover initiative. In response to the prime mover's selection of the enabler, a notification of the selection can be forwarded to the enabler.

Enabler selection notifier 211 provides access to an indicator of a prime mover's selection of an enabler to the enabler. In one embodiment, the indicator is transmitted to the enabler (for example a personal computer, lap top or phone of the enabler). In another embodiment, the indicator can be accessed by the enabler after prompting.

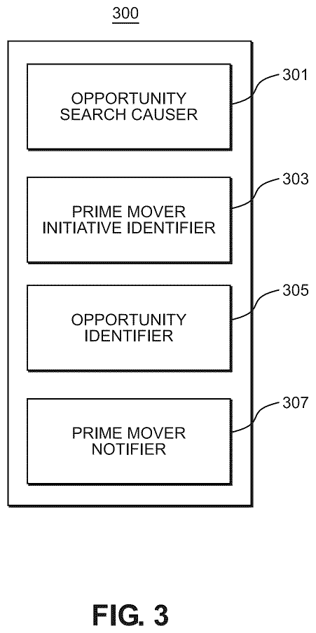

FIG. 3 shows components of a system 300 for identifying prime mover initiatives of a system 22a for opportunity serving according to one embodiment. In one embodiment, system 300 for identifying prime mover initiatives of a system 22a for opportunity serving includes opportunity search causer 301, prime mover initiative identifier 303, opportunity identifier 305 and prime mover notifier 307.

Opportunity search causer 301, responsive to a prompt to initiate a search, causes a search for opportunities for enablers to use the factors of production that they possess. In one embodiment, the prompt to initiate the search is provided by the enabler. In one embodiment, the prompt to initiate the search is automatically provided by the system. In one embodiment, the enabler can determine automatic prompting. In one embodiment, the system can determine automatic prompting. In one embodiment, if the system determines automatic prompting, the automatic prompting can be based on system policy. In one embodiment, if the system determines automatic prompting, the automatic prompting can be random, continuous or periodic.

Prime mover initiative identifier 303 identifies prime mover initiatives that require the factors of production that are possessed by the enabler. In one embodiment, the prime mover initiatives can be categorized according to its area of economic activity. For example, the areas of economic activity can include service (e.g., retail, professional and non-professional services), manufacturing, and production of raw materials (e.g., mining, and farming). In other embodiments, the prime mover initiatives may not be categorized according to area of economic activity.

Opportunity identifier 305 identifies opportunities for enablers from identified prime mover initiatives. In one embodiment the opportunities can be opportunities to provide factors of production that are required by a prime mover initiative. In one embodiment, the opportunities are identified from groups of opportunities categorized by area of economic activity. In other embodiments, the opportunities may not be categorized by area of economic activity.

Prime mover notifier 307 accesses an indication of an enabler's interest in providing factors of production for a prime mover initiative and notifies the prime mover of the indicated interest of the enabler.

FIGS. 2 and 3 illustrate an example manner of implementing the system 22a of FIG. 1A. In an embodiment, one or more of the elements, processes, components and/or devices of the system 22a may be integrated, separated, re-arranged, omitted, eliminated and/or implemented in other manners. In an embodiment, the components of system 22a can be implemented using hardware, software, firmware and/or any combination thereof. In particular, components of system 22a can be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). In an embodiment, as regards software and/or firmware implementation of the opportunity server system 22a, at least one of the components of such is/are hereby expressly defined to include a non-transitory computer readable storage device or storage disk such as a memory, a digital versatile disk (DVD), a compact disk (CD), a Blu-ray disk, etc. including the software and/or firmware. It should be appreciated that, the opportunity server system 22a can include one or more elements, processes and/or devices in addition to, or instead of, those illustrated in FIGS. 2 and 3, and/or may include more than one of any or all of the illustrated elements, processes and devices.

### Flowcharts of Methods for Opportunity Serving

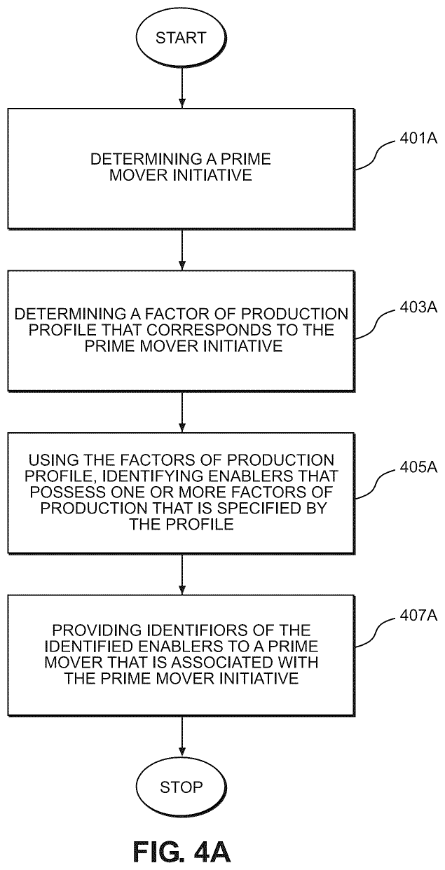

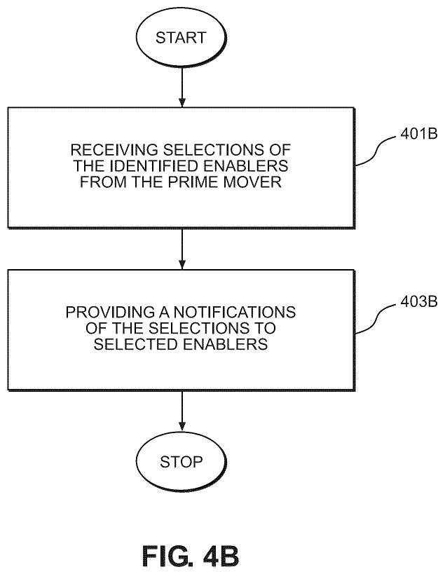

FIG. 4A shows a flowchart of a method for identifying enablers for a prime mover initiative according to one embodiment.

Referring to FIG. 4A, at 401A, a prime mover initiative is determined. Referring to FIG. 2, the prime mover initiative determiner 201 determines a business initiative that a prime mover is interested in pursuing or is qualified to pursue. In one embodiment, an identification of the business initiative is provided by the prime mover. In one embodiment, an identification of the business initiative is determined by the system 200. In one embodiment, the system 200 can determine the business initiative by examining the personal profile of the prime mover. In one embodiment, the system 200 can determine the business initiative by examining the personal profile for information related to the prime mover that can include but is not limited to education, training, work experience and control of factors of production.

At 403A, a factors of production profile is determined that corresponds to the prime mover initiative. Referring to FIG. 2, initiative type factors of production profile determiner 203 identifies an initiative type factors of production profile that corresponds to the type of prime mover initiative that the prime mover is interested in pursuing or is qualified to pursue. In one embodiment, the initiative type factors of production profiles are maintained in data storage components associated with system 200. In one embodiment, the initiative type that the prime mover is interested in pursuing or is qualified to pursue can be provided by the prime mover or can be determined by the initiative type factors of production profile determiner 203 by examining the personal profile of a potential prime mover to determine the type of initiatives which the potential prime mover is qualified to act as a prime mover. In one embodiment, the initiative type factors of production profile that is identified can be used to identify enablers that possess the factors of production needed by the prime mover initiative.

At 405A, using the factors of production profile, enablers are identified that possess one or more factors of production that are specified by the profile. Referring to FIG. 2, enabler identifier 205 identifies the prime mover initiative enablers that possess the factors of production that are needed to support the operationalization of the prime mover initiative that is associated with the prime mover. In one embodiment, enabler identifier 205 uses an initiative type factors of production profile to identify the enablers. In one embodiment, the initiative type factors of production profile can be used to search data storage components that store the personal profiles of system users. In one embodiment, when enablers are identified that match the criteria specified by the initiative type factors of production profile, their identities are provided to the prime mover associated with the initiative.

At 407A, identifiers of the identified enablers are provided to a prime mover that is associated with the prime mover initiative. Referring to FIG. 2, enabler identifier provider 207 provides the identities of identified enablers to the prime mover. In one embodiment, where multiple enablers meet the criteria specified in the initiative type factors of production profile, the identities of the identified enablers that are provided to the prime mover can be ranked. In one embodiment, where multiple enablers meet the criteria specified in the profile, and the identities of the identified enablers are ranked, all of the ranked enablers identities or a specified number of the ranked enablers identities can be provided to the prime mover. In one embodiment, the specified number can determined by the prime mover. In other embodiments, the specified number can be determined by the system.

FIG. 4B shows a flowchart of a method for notifying enablers of their selection for a prime mover initiative according to one embodiment.

Referring to FIG. 4B, at 401B, a selection of the identified enablers are received from the prime mover. Referring to FIG. 2, enabler selection receiver 209 accesses an indicator of a prime mover's selection of an enabler identified by a search of data storage components using the initiative type factors of production profile that is identified for the prime mover initiative. In response to the prime mover's selection of the enabler, a notification of the selection can be forwarded to the enabler.

At 403B, a notification of the selections are provided to the selected enablers. Referring to FIG. 2, enabler selection notifier 211 provides access to an indicator of a prime mover's selection of an enabler to the enabler. In one embodiment, the indicator is transmitted to the enabler (for example a personal computer, lap top or phone of the enabler). In another embodiment, the indicator can be accessed by the enabler after prompting.

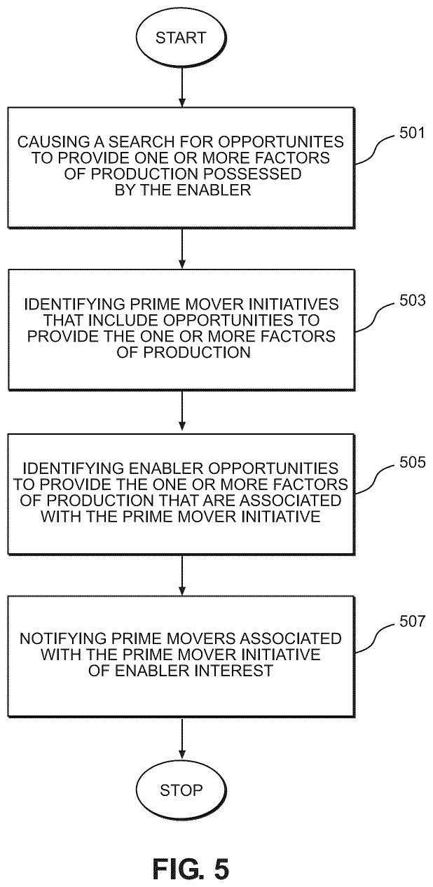

FIG. 5 shows a flowchart of a method for identifying prime mover initiatives according to one embodiment.

Referring to FIG. 5, at 501 responsive to a prompt to initiate a search, a search for opportunities for enablers to use the talent and/or resources that they possess is caused. Referring to FIG. 3, opportunity search causer 301, responsive to a prompt to initiate a search, causes a search for opportunities for enablers to use the factors of production that they possess. In one embodiment, the prompt to initiate the search is provided by the enabler. In one embodiment, the prompt to initiate the search is automatically provided by the system. In one embodiment, the enabler can determine automatic prompting. In one embodiment, the system can determine automatic prompting. In one embodiment, if the system determines automatic prompting, the automatic prompting can be based on system policy. In one embodiment, if the system determines automatic prompting, the automatic prompting can be random, continuous or periodic.

At 503, prime mover initiatives are identified, that require the talent and/or resources that are presented by the enabler. Referring to FIG. 3, prime mover initiative identifier 303 identifies prime mover initiatives that require the factors of production that are possessed by the enabler. In one embodiment, the prime mover initiatives can be categorized according to its area of economic activity. For example, the areas of economic activity can include service (e.g., retail, professional and non-professional services), manufacturing, and production of raw materials (e.g., mining, and farming). In other embodiments, the prime mover initiatives may not be categorized according to area of economic activity.

At 505, opportunities for enablers are identified. Opportunity identifier 305 identifies opportunities for enablers from identified prime mover initiatives. Referring to FIG. 3, in one embodiment the opportunities can be opportunities to provide factors of production that are required by a prime mover initiative. In one embodiment, the opportunities are identified from groups of opportunities categorized by area of economic activity. In other embodiments, the opportunities may not be categorized by area of economic activity.

At 507, an indication of an enabler's interest in providing talent and/or resources for a prime mover initiative is accessed and the prime mover is notified of the indicated interest of the enabler. Referring to FIG. 3, prime mover notifier 307 accesses an indication of an enabler's interest in providing factors of production for a prime mover initiative and notifies the prime mover of the indicated interest of the enabler. In one embodiment, the indication can be made by.

In an embodiment, the operations of the flowcharts shown in FIGS. 4A, 4B and 5 can correspond to machine readable instructions of a program that can be executed by a processor 24 of a computer system 20. In some embodiments, the program and/or portions or parts thereof can be executed by a device other than a processor. The program can be stored on a non-transitory machine or computer readable storage medium such as a hard drive, a digital versatile disk (DVD), a read-only memory, a compact disk, a floppy disk, a Blu-ray disk, a cache, a random-access memory or other storage device. As used herein, the term non-transitory computer readable medium is intended to refer to computer readable storage devices and/or storage disks and to exclude propagating signals and to exclude transmission media. In some embodiments, the program can be embodied in firmware or dedicated hardware. In an embodiment, one or more of the operations of the flowchart can be performed without executing software or firmware. For example, one or more of the blocks may be implemented by one or more hardware circuits such as a Field Programmable Gate Array (FPGA), an Application Specific Integrated circuit (ASIC), a discrete and/or integrated analog and/or digital circuit, a comparator, an operational-amplifier (op-amp), a logic circuit, etc. It should be noted that the order of execution of the blocks of the flowcharts of FIGS. 4A, 4B and 5 may be changed. In addition, one or more of the blocks of the flowchart can be eliminated or added.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device. Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

Referring again to FIG. 1A, the computer system 20 can include a processor(s) or microprocessor(s) 24 and data storage components such as registered user data storage 28 and system data storage 30. In an embodiment, the processor(s) and/or microprocessor(s) and data storage components (memory) can be connected by an interconnect (e.g., bus and system core logic). In addition, the processor(s) and/or microprocessor(s) can be coupled to cache memory (not shown). In an embodiment, the interconnect can connect the microprocessor(s) 24 and the data storage components to input/output (I/O) device(s) via I/O controller(s). I/O devices can include a display device and/or peripheral devices, such as mice, keyboards, modems, network interfaces, printers, scanners, video cameras and other devices known in the art. In an embodiment, (e.g., when the data processing system is a server system) some of the I/O devices, such as printers, scanners, mice, and/or keyboards, can be optional.

In an embodiment, the interconnect can include one or more buses connected to one another through various bridges, controllers and/or adapters. In one embodiment, the I/O controllers can include a USB (Universal Serial Bus) adapter for controlling USB peripherals, and/or an IEEE-1394 bus adapter for controlling IEEE-1394 peripherals.

In an embodiment, the data storage components can include one or more of: ROM (Read Only Memory), volatile RAM (Random Access Memory), and non-volatile memory, such as hard drive, flash memory, etc. Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of the present disclosure. The scope of the present disclosure includes any feature or combination of features disclosed herein (either explicitly or implicitly), or any generalization thereof, whether or not it mitigates any or all of the problems addressed herein. Accordingly, new claims may be formulated during prosecution of the present application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The various features of the different embodiments may be variously combined with some features included and others excluded to suit a variety of different applications.

What is claimed is:

1. A method, comprising:
determining a prime mover initiative;
determining a factors of production profile that corresponds to the prime mover initiative;
using the factors of production profile, identifying enablers that possess one or more factors production that is specified by the factors of production profile; and
providing identifiers of the identified enablers to a prime mover that is associated with the prime mover initiative.

2. The method of claim 1, further comprising receiving selections of the identified enablers from the prime mover; and providing an indication of the selections to the identified enablers.

3. The method of claim 1, wherein the determining the factors of production profile that corresponds to the prime mover initiative includes determining whether the prime mover initiative is an entrepreneurial, business or investment initiative.

4. The method of claim 3, wherein the determining the factors of production profile that corresponds to the prime mover initiative includes determining a type of entrepreneurial, business or investment initiative.

5. The method of claim 1, wherein the identifying enablers that possess one or more factors of production that is specified by the factors of production profile includes identifying enablers that have been categorized according to the factors of production that they provide.

6. The method of claim 5, wherein the identifying enablers that possess one or more factors of production that is specified by the factors of production profile includes searching the categorized enablers for factors of production that match factors of production specified by the factors of production profile.

7. A computer system, comprising:
a processor; and
data storage component, that stores data that when executed cause the processor to:
determine a prime mover initiative;
determine a factors of production profile that corresponds to the prime mover initiative;
using the factors of production profile, identify enablers that possess one or more factors production that is specified by the factors of production profile; and
provide identifiers of the identified enablers to a prime mover that is associated with the prime mover initiative.

8. The computer system of claim 7, further comprising causing the processor to: receive selections of the identified enablers from the prime mover; and provide an indication of the selections to the identified enablers.

9. The computer system of claim 7, wherein the determine the factors of production profile that corresponds to the prime mover initiative includes determine whether the prime mover initiative is an entrepreneurial, business or investment initiative.

10. The computer system of claim 9, wherein the determine the factors of production profile that corresponds to the prime mover initiative includes determine a type of entrepreneurial, business or investment initiative.

11. The computer system of claim 7, wherein the identify enablers that possess one or more factors of production that is specified by the factors of production profile includes identify enablers that have been categorized according to the factors of production that they provide.

12. The computer system of claim 11, wherein the identify enablers that possess one or more factors of production that is specified by the factors of production profile includes search the categorized enablers for factors of production that match factors of production specified by the factors of production profile.

13. The computer system of claim 7, wherein the provide identifiers of the identified enablers to a prime mover that is associated with the prime mover initiative includes provide respective identifiers associated with respective enablers to the prime mover.
